(19) United States
(12) Patent Application Publication
(10) Pub. No.: US 2021/0031542 A1
(43) Pub. Date: Feb. 4, 2021

(54) IMAGE FORMING APPARATUS

(71) Applicants: Kazuaki KAMIHARA, Tokyo (JP); Hiroshi Sawase, Kanagawa (JP); Masato Ogawa, Kanagawa (JP); Yoshihiro Takahashi, Tokyo (JP); Kohki Asada, Tokyo (JP); Kenji Nozawa, Ibaraki (JP)

(72) Inventors: Kazuaki KAMIHARA, Tokyo (JP); Hiroshi Sawase, Kanagawa (JP); Masato Ogawa, Kanagawa (JP); Yoshihiro Takahashi, Tokyo (JP); Kohki Asada, Tokyo (JP); Kenji Nozawa, Ibaraki (JP)

(21) Appl. No.: 16/940,603

(22) Filed: Jul. 28, 2020

(30) Foreign Application Priority Data
Aug. 2, 2019 (JP) 2019-143256

(51) Int. Cl. B41J 11/00; C09D 11/38; B41J 13/03; B41M 5/00; B41J 3/60; B65H 5/06; B41M 7/00

(52) U.S. Cl. CPC B41J 11/002; C09D 11/38; B41J 13/03; B41J 2/01; B41J 3/60; B65H 5/062; B41M 7/0081; B41M 5/0017

(57) ABSTRACT

An image forming apparatus includes an applicator and an irradiator. The applicator is configured to apply a liquid composition containing water or an organic solvent onto a recording medium. The irradiator is configured to irradiate the recording medium with light having a peak wavelength of 300 nm to 450 nm.

### CROSS-REFERENCE TO RELATED APPLICATION

This patent application is based on and claims priority pursuant to 35 U.S.C. § 119(a) to Japanese Patent Application No. 2019-143256, filed on Aug. 2, 2019, in the Japan Patent Office, the entire disclosure of which is incorporated by reference herein.

### BACKGROUND

### Technical Field

Embodiments of the present disclosure relate to an image forming apparatus.

### Related Art

In image formation by an inkjet method, it is known to use an infrared (IR) lamp or a near infrared (NIR) lamp as means for drying ink after the ink is discharged.

In a drying method using an IR lamp, the wavelength of irradiation is around 3000 nm and the energy for vibrating water molecules is provided. Therefore, at the same time as ink is dried, the IR lamp also heats a region (blank portion) where the ink is not discharged and an image is not formed, thus evaporating moisture of the recording medium. Accordingly, after the output of a printed material, the blank portion whose moisture content has decreased may absorb moisture in the atmosphere again and wave.

On the other hand, in a drying method using the NIR lamp, the wavelength of irradiation is around 1000 nm. In such a range, ink has a higher energy absorption rate than water, and the effect of not heating the blank portion can be expected. However, since the energy absorption rate greatly varies depending on the type of ink, drying unevenness of the ink or excessive heating of a specific ink may occur. In addition, when the drying method using the NIR lamp is used in combination with another method, such as heat transfer, of generating the waviness (also referred to as cockling or the like) of the blank portion, the effect of restraining the waviness of the blank portion may not be sufficiently obtained.

In image formation by an inkjet method, there has also been proposed a technique using an ultraviolet (UV) curable material such as a UV curable ink (UV ink). For example, there has been proposed a technique in which an active energy ray-curable pretreatment liquid is applied to a recording medium, then an aqueous ink for inkjet recording is discharged, and then UV irradiation is performed.

### SUMMARY

In an aspect of the present disclosure, there is provided an image forming apparatus that includes an applicator and an irradiator. The applicator is configured to apply a liquid composition containing water or an organic solvent onto a recording medium. The irradiator is configured to irradiate the recording medium with light having a peak wavelength of 300 nm to 450 nm.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a schematic view of an image forming apparatus according to an embodiment of the present disclosure;

FIG. 2 is a schematic view of an example of an irradiator;

FIG. 3 is a graph illustrating correlation between image portion temperature and blank portion temperature after drying;

FIG. 4 is a graph illustrating how much a blank portion is waved as a result of re-absorption of moisture after output; and

FIGS. 5A to 5C are schematic views illustrating a cover structure of the irradiator.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

Hereinafter, an image forming apparatus according to an embodiment of the present disclosure is described with reference to the drawings. Note that the following embodiments are not limiting the present disclosure and any deletion, addition, modification, change, etc. can be made within a scope in which person skilled in the art can conceive including other embodiments, and any of which is included within the scope of the present disclosure as long as the effect and feature of the present disclosure are demonstrated.

The image forming apparatus according to the present embodiment is an image forming apparatus that includes: a first applicator configured to apply a liquid composition containing water or an organic solvent onto a recording medium; and an irradiator configured to irradiate the recording medium with light having a peak wavelength of 300 nm to 450 nm. The liquid composition may or may not contain an ultraviolet polymerization initiator and an ultraviolet polymerizable compound. The liquid composition contains less than 0.1% by mass of the ultraviolet polymerization initiator or less than 5% by mass of the ultraviolet polymerizable compound.

According to the present embodiment, waviness in a region of the recording medium on which no image is formed can be restrained. Hereinafter, a blank portion of the recording medium on which no image is formed may be referred to as a “white sheet region”. However, the color of the blank portion on which no image is formed and the color of the recording medium are not limited to white. A region to which the liquid composition has been applied may be referred to as a region on which an image has been formed, and the image may be colored or colorless.

In the present embodiment, the liquid composition in which the content of the ultraviolet polymerization initiator or the ultraviolet polymerizable compound is set to less than a predetermined amount is applied to a recording medium, and the recording medium is irradiated with light having a peak wavelength of 300 nm to 450 nm to be dried. Accordingly, only the liquid composition can be dried without heating the blank portion, thus restraining the recording medium from reabsorbing moisture in the atmosphere after output, and restraining the blank portion from being waved. In addition, a cockling correction device, which need be separately provided otherwise, can be omitted, thus allowing space saving and further cost reduction.

Inks of black (K), cyan (C), magenta (M), and yellow (Y) have substantially the same energy absorptance with respect to light having a peak wavelength of 300 nm to 450 nm. Therefore, in a case where the KCMY inks are used as the liquid compositions, using light having a peak wavelength of 300 nm to 450 nm can reduce a difference in drying progress between the inks and restrain drying unevenness. Further, since a difference in drying progress between the inks is less likely to occur, it is not necessary to use the drying method in combination with other drying methods, thus more effectively restraining waviness of the blank portion.

In addition, in the liquid composition used in the present embodiment, the content of the ultraviolet polymerization initiator or the ultraviolet polymerizable compound is restrained, thus reducing the running cost. Further, since the content of the ultraviolet polymerization initiator or the ultraviolet polymerizable compound is restrained, a printed material having good safety can be obtained. In addition, since a printed material has good safety, the liquid composition used in the present embodiment can also be used for printing food packages and the like for which food safety is required.

<First Applicator and Second Applicator>

The first applicator applies a liquid composition containing water or an organic solvent onto a recording medium. The second applicator applies a curable composition, which is to be cured by light irradiated by the irradiator described below, to the recording medium before the irradiator irradiates the recording medium with light. Hereinafter, when the first applicator and the second applicator are described without being distinguished from each other, the first applicator and the second applicator are simply referred to as applicators.

As the applicator, for example, an inkjet head can be used. When an inkjet head is used, the inkjet head may be a line type or a serial type. The number of applicators provided in the image forming apparatus can be appropriately changed, and may be one or more.

<Irradiator>

The irradiator irradiates the recording medium with light having a peak wavelength of 300 nm to 450 nm. In the present embodiment, when the recording medium is irradiated with the light through a wavelength cut filter or the like, the peak wavelength of the light irradiated by the irradiator is determined after the light passes through the wavelength cut filter or the like.

When the wavelength of the irradiated light is 300 nm to 450 nm, the above-described desired effect is obtained. If the wavelength of the irradiated light is less than 300 nm, there is an increased risk of adverse effects (such as inflammation) on the human body when even a small amount of UV light leaks from the printing apparatus. When the average particle diameter is larger than 450 nm, the difference in light absorption rate between the ink colors becomes large, and drying unevenness occurs. For example, black ink having a high absorption rate is heated to a high temperature, whereas cyan ink having a low absorption rate is not so dried, so that the entire printed image cannot be uniformly dried.

The irradiation position on the recording medium and the emission intensity of the irradiator are not particularly limited, and can be appropriately changed. In addition, the number of irradiators provided in the image forming apparatus can be appropriately changed, and may be one or more.

As the irradiator, for example, an ultraviolet irradiation device (also referred to as a UV light irradiation device or the like) can be used. When UV light is irradiated, it is particularly preferable to irradiate light having a peak wavelength of 300 nm to 400 nm.

As the irradiator, a light emitting diode (LED) is preferably used as a light source, and in particular, a light emitting diode emitting ultraviolet rays (hereinafter, referred to as a UV-LED) is preferably used. In the case of using an LED, unlike a metal halide lamp or the like, the wavelength tends to be sharp at a single peak as a light source without using a wavelength cut filter. For example, even in the case of using ink as a liquid composition, the difference in the progress of drying due to the color difference of the ink can be reduced.

The wavelength distribution of the light irradiated by the irradiator is not particularly limited and can be appropriately changed. For example, the full width at half maximum may be about 15 nm.

It is preferable that the irradiator is covered with a first cover member and a second cover member. The first cover member is openable and closable to cover the irradiator. The second cover member is openable and closable to cover the first cover member. In this case, the irradiator can be said to be covered with the double covers.

In this case, it is preferable that the irradiator performs light irradiation when the second cover member is closed. For example, it is preferable that an interlock of the irradiator is interlocked with the outer cover (second cover member). Accordingly, if the light such as the UV light is reliably turned off before the inner cover (first cover member) is opened, the operator can be prevented from seeing the UV light.

The material of the cover member is not particularly limited as long as the material can block the light of the irradiator.

<Liquid Composition>

The liquid composition used in the present embodiment contains water or an organic solvent, and optionally contains other components such as a colorant and a resin. The liquid composition used in the present embodiment may contain an ultraviolet polymerization initiator and an ultraviolet polymerizable compound.

The liquid composition can be used as, for example, a coloring ink, a pretreatment liquid (undercoat liquid), an aftertreatment liquid (protector coat liquid), or the like. When the liquid composition used in the present embodiment is used as an ink, the ink may be referred to as an aqueous ink.

In the case where a colorant such as a pigment or a dye is contained in the liquid composition, the colorant absorbs light irradiated by the irradiator, converts the light into thermal energy, and generates heat. When the temperature of the liquid composition rises, water and the organic solvent evaporate, and when the liquid composition contains a resin, the resin melts and a printed image is fixed to the recording medium. In such a drying process, safety is easily ensured because there are sufficiently few or no substances in an active state. Note that in the case where a pigment is used as a colorant in the liquid composition, the liquid composition is less likely to be discolored even when irradiated with light such as UV light than in the case where a dye is used, and thus a vivid printed image can be obtained.

—Ultraviolet Polymerization Initiator and Ultraviolet Polymerizable Compound—

The liquid composition used in the present embodiment may contain an ultraviolet polymerization initiator and an ultraviolet polymerizable compound. However, in the case of containing an ultraviolet polymerization initiator and an ultraviolet polymerizable compound, the contents of the ultraviolet polymerization initiator and the ultraviolet polymerizable compound are restrained to less than a predetermined amount. Accordingly, even when light is irradiated by the irradiator, curing due to a polymerization reaction does not occur or hardly occurs.

When the liquid composition contains the ultraviolet polymerization initiator and the ultraviolet polymerizable compound, the content of the ultraviolet polymerization initiator in the liquid composition is less than 0.1% by mass, or the content of the ultraviolet polymerizable compound in the liquid composition is less than 5% by mass. When the liquid composition contains the ultraviolet polymerization initiator in an amount of 0.1% by mass or more and the ultraviolet polymerizable compound in an amount of 5% by mass or more, the cost is increased and a printed material having good safety is not obtained.

Examples of the ultraviolet polymerization initiator include those capable of generating an active species such as a radical or a cation by UV (ultraviolet ray) and initiating polymerization of a polymerizable compound (monomer or oligomer). As such a polymerization initiator, a known radical polymerization initiator, a known cationic polymerization initiator, a known base generator, or the like may be used alone or in combination of two or more.

Specific examples of the radical polymerization initiators include, but are not limited to, aromatic ketones, acylphosphine oxide compounds, aromatic onium salt compounds, organic peroxides, thio compounds (e.g., thioxanthone compounds and thiophenyl-group-containing compounds), hexaaryl biimidazole compounds, ketoxime ester compounds, borate compounds, azinium compounds, metallocene compounds, active ester compounds, carbon-halogen-bond-containing compounds, and alkylamine compounds.

The ultraviolet polymerizable compound is not particularly limited and can be appropriately changed. For example, a known polymerizable compound can be used. The polymerizable compound may be a monomer or an oligomer. Examples of the polymerizable compound include methacrylic acid.

—Water—

The content of water in the liquid composition is not particularly limited and may be appropriately selected depending on the intended purpose. The content of water is preferably 10% by mass or more and 90% by mass or less, more preferably 20% by mass or more and 60% by mass or less, from the viewpoint of drying properties and discharge reliability.

—Organic Solvent—

The organic solvent used in the present disclosure is not particularly limited, and a water-soluble organic solvent can be used. Examples thereof include, but are not limited to, polyols, ethers such as polyol alkyl ethers and polyol aryl ethers, nitrogen-containing heterocyclic compounds, amides, amines, and sulfur-containing compounds.

Specific examples of the polyols include, but are not limited to, ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, polypropylene glycol, 1,2-pentanediol, 1,3-pentanediol, 1,4-pentanediol 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and petriol.

Examples of the polyol alkyl ethers include, but are not limited to, ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether.

Examples of polyol aryl ethers include, but are not limited to, ethylene glycol monophenyl ether and ethylene glycol monobenzyl ether.

Examples of nitrogen-containing heterocyclic compounds include, but are not limited to, 2-pyrrolidone, N-methyl-2-pyrrolidone, N-hydroxyethyl-2-pyrrolidone, 1,3-dimethyl-2-imidazolidinone, ε-caprolactam, and γ-butyrolactone. Examples of the amides include, but are not limited to, formamide, N-methylformamide, N,N-dimethylformamide, 3-methoxy-N,N-dimethylpropionamide, and 3-butoxy-N,N-dimethylpropionamide.

Examples of amines include, but are not limited to, monoethanolamine, diethanolamine, and triethylamine.

Examples of sulfur-containing compounds include, but are not limited to, dimethyl sulfoxide, sulfolane, and thiodiethanol.

Examples of other organic solvents include, but are not limited to, propylene carbonate and ethylene carbonate.

In particular, organic solvents having a boiling point of 250° C. or less are preferable since such organic solvents can function as a wetting agent while providing good drying property.

As the organic solvent, a polyol compound having 8 or more carbon atoms and a glycol ether compound are also preferably used. Specific examples of the polyol compounds having 8 or more carbon atoms include, but are not limited to, 2-ethyl-1,3-hexanediol and 2,2,4-trimethyl-1,3-pentanediol.

Specific examples of the glycol ether compounds include, but are not limited to, polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; and polyol aryl ethers such as ethylene glycol monophenyl ether and ethylene glycol monobenzyl ether.

The polyol compounds having 8 or more carbon atoms and the glycol ether compounds are capable of improving paper-permeability of the ink, which is advantageous when paper is used as a recording medium.

The content of the organic solvent in the liquid composition is not particularly limited and may be appropriately selected depending on the intended purpose, but is preferably 10% by mass or more and 60% by mass or less, more preferably 20% by mass or more and 60% by mass or less, from the viewpoint of drying properties and discharge reliability.

—Content of Water and Organic Solvent—

The total amount of water and organic solvent in the liquid composition is preferably 80% by mass or more, and more preferably 90% by mass or more. In this case, the discharge performance can be enhanced.

—Colorant—

The colorant is not particularly limited, and pigments and dyes can be used. Usable pigments include both inorganic pigments and organic pigments. Each of the pigments may be used alone or two or more of these may be used in combination. A mixed crystal may be used as the pigment.

Usable pigments include, but are not limited to, black pigments, yellow pigments, magenta pigments, cyan pigments, white pigments, green pigments, orange pigments, glossy color pigments (e.g., gold pigments and silver pigments), and metallic pigments.

Specific examples of inorganic pigments include, but are not limited to, titanium oxide, iron oxide, calcium carbonate, barium sulfate, aluminum hydroxide, Barium Yellow, Cadmium Red, Chrome Yellow, and carbon black produced by a known method such as a contact method, a furnace method, and a thermal method.

Specific examples of organic pigments include, but are not limited to, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, quinophthalone pigments), dye chelates (e.g., basic dye chelate, acid dye chelate), nitro pigments, nitroso pigments, and aniline black. Among these pigments, those having good affinity for solvents are preferable. In addition, hollow resin particles and hollow inorganic particles can also be used.

Specific examples of pigments used for black-and-white printing include, but are not limited to: carbon blacks (i.e., C.I. Pigment Black 7) such as furnace black, lamp black, acetylene black, and channel black; metals such as copper, iron (i.e., C.I. Pigment Black 11), and titanium oxide; and organic pigments such as aniline black (i.e., C.I. Pigment Black 1).

Specific examples of pigments used for color printing include, but are not limited to: C.I. Pigment Yellow 1, 3, 12, 13, 14, 17, 24, 34, 35, 37, 42 (Yellow Iron Oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red 1, 2, 3, 5, 17, 22, 23, 31, 38, 48:2, 48:2 (Permanent Red 2B(Ca)), 48:3, 48:4, 49:1, 52:2, 53:1, 57:1 (Brilliant Carmine 6B), 60:1, 63:1, 63:2, 64:1, 81, 83, 88, 101 (Red Iron Oxide), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1,2,15 (Phthalocyanine Blue), 15:1, 15:2, 15:3, 15:4 (Phthalocyanine Blue), 16, 17:1, 56, 60, and 63; and C.I. Pigment Green 1,4,7,8,10,17,18, and 36.

The dyes are not particularly limited, and acid dyes, direct dyes, reactive dyes, and basic dyes can be used. Each of these can be used alone or in combination with others.

Specific examples of the dyes include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the colorant in the liquid composition is preferably from 0.1% to 15% by mass, more preferably from 1% to 10% by mass, for improving image density, fixability, and discharge stability.

Examples of the method of dispersing the pigment in the liquid composition include, but are not limited to, a method of introducing a hydrophilic functional group to the pigment to make the pigment self-dispersible, a method of covering the surface of the pigment with a resin to disperse the pigment; and a method of dispersing the pigment by a dispersant. In the method of introducing a hydrophilic functional group to the pigment to make the pigment self-dispersible, for example, a functional group such as sulfone group and carboxyl group may be introduced to the pigment (e.g., carbon) to make the pigment dispersible in water.

Examples of the method for coating a surface of the pigment with a resin to disperse the pigment include a method for making a pigment encapsulated in a microcapsule such that the pigment can be dispersed in water. In this case, the pigment may be referred to as a resin-coated pigment. In this case, it is not necessary that all of the pigment blended in the liquid composition is coated with the resin, and an uncoated pigment or a partially coated pigment may be dispersed in the liquid composition as long as the effects of the present invention are not impaired.

In the method of dispersing the pigment by a dispersant, low-molecular dispersants and high-molecular dispersants, represented by known surfactants, may be used. More specifically, any of anionic surfactants, cationic surfactants, ampholytic surfactants, and nonionic surfactants may be used as the dispersant depending on the property of the pigment. As a dispersant, RT-100 (nonionic surfactant) manufactured by Takemoto Yushi Co., Ltd. and naphthalenesulfonic acid Na formalin condensate can also be suitably used as the dispersant. Each of the above dispersants may be used alone or in combination with others.

A liquid composition such as an ink can be obtained by mixing a pigment with a material such as water or an organic solvent. The liquid composition can also be obtained by, first, preparing a pigment dispersion by mixing a pigment with water, a dispersant, etc., and thereafter mixing the pigment dispersion with other materials such as water and an organic solvent.

The pigment dispersion can be obtained by mixing water, a pigment, a pigment dispersant, and other components, if any, to disperse the pigment, and adjusting the particle diameter of the pigment. Preferably, the dispersing is performed by a disperser.

Preferably, the pigment dispersed in the pigment dispersion has a maximum frequency particle diameter in the range of from 20 to 500 nm, more preferably from 20 to 150 nm, based on the number of pigment particles, from the aspects of dispersion stability of the pigment and discharge stability and image quality (e.g., image density) of the ink. The particle diameter of the pigment can be measured with a particle size analyzer (NANOTRAC WAVE-UT151 available from MicrotracBEL Corp.).

The proportion of the pigment in the pigment dispersion is not particularly limited and can be suitably selected to suit to a particular application, but is preferably from 0.1% to 50% by mass, more preferably from 0.1% to 30% by mass, for improving discharge stability and enhancing image density. Preferably, the pigment dispersion is subjected to filtration using a filter or a centrifugal separator to remove coarse particles, followed by degassing.

—Resin—

The type of the resin contained in the liquid composition is not particularly limited and can be suitably selected to suit to a particular application. Specific examples thereof include, but are not limited to, urethane resins, polyester resins, acrylic resins, vinyl acetate resins, styrene resins, butadiene resins, styrene-butadiene resins, vinyl chloride resins, acrylic styrene resins, and acrylic silicone resins. Resin particles made of these resins may also be used. The resin particles may be dispersed in water as a dispersion medium to prepare a resin emulsion. The liquid composition can be obtained by mixing the resin emulsion with other materials such as a colorant and an organic solvent. The resin particles may be suitably synthesized or a commercial product. As the resin particles, one type of resin particles may be used alone or two or more types of resin particles may be used in combination.

The volume average particle diameter of the resin particles is not particularly limited and can be suitably selected to suit to a particular application, but is preferably from 10 to 1,000 nm, more preferably from 10 to 200 nm, and particularly preferably from 10 to 100 nm, for good fixability and high image hardness. The volume average particle diameter can be measured with a particle size analyzer (NANOTRAC WAVE-UT151 available from MicrotracBEL Corp.).

The proportion of the resin in the liquid composition is not particularly limited and can be suitably selected to suit to a particular application, but is preferably from 1% to 30% by mass, more preferably from 5% to 20% by mass, for fixability and storage stability of the liquid composition.

—Other Components—

The liquid composition may further contain a surfactant, a defoamer, a preservative, a fungicide, a corrosion inhibitor, and/or a pH adjuster.

—Pretreatment Liquid (Undercoat Liquid)—When the liquid composition is used as a pretreatment liquid, the pretreatment liquid contains an organic solvent and water, and may optionally contain an agglomeration agent, a surfactant, a defoamer, a pH adjuster, a preservative, a fungicide, and/or a corrosion inhibitor. Examples of the organic solvent, surfactant, defoamer, pH adjuster, preservative, fungicide, and corrosion inhibitor include the same materials as those used for the liquid composition and known materials used for treatment liquids. The agglomeration agent is not particularly limited. Examples thereof include, but are not limited to, water-soluble cationic polymers, acids, and polyvalent metal salts.

—Aftertreatment Liquid (Protector Coating Liquid)—

When the liquid composition is used as an aftertreatment liquid, the aftertreatment liquid is not particularly limited as long as it is capable of forming a transparent layer. The aftertreatment liquid may be prepared by mixing an organic solvent and water with a resin, a surfactant, a defoamer, a pH adjuster, a preservative, a fungicide, and/or a corrosion inhibitor, selected according to the need. The aftertreatment liquid can be applied to the entire recording area on a recording medium or only a selected area.

<Recording Medium>

Specific examples of the recording medium include, but are not limited to, plain paper, glossy paper, special paper, clothes, film, overhead projector (OHP) transparency, and general-purpose printing paper.

<Curable Composition>

In the present embodiment, in addition to the liquid composition, a curable composition that is cured by light irradiated by the irradiation unit may be applied to the recording medium. In the case of using such a curable composition, since the curable composition can be cured simultaneously with the drying of the liquid composition by the above-described irradiator, there is an advantage that it is not necessary to separately provide a curing means.

The curable composition can be used as coloring ink, white ink, clear ink, pretreatment liquid (undercoat liquid), aftertreatment liquid (protector coat liquid), or the like. Among these, the curable composition is preferably used as white ink or clear ink. When the curable composition is used as UV curable ink, the UV curable ink may also be referred to as UV ink.

In the case of using the curable composition, although it is inferior to the case of not using the curable composition in terms of safety and cost, a printed matter with added value can be obtained by adding a special color such as white or clear. In addition, in the present embodiment, even when the curable composition is used, the liquid composition can be used in combination, and thus, for example, compared to a conventional example in which all of a black ink, a cyan ink, a magenta ink, a yellow ink, and a white ink are UV curable inks, a running cost is reduced, and a printed material having good safety is obtained.

In the case of using the curable composition, the order of applying the curable composition to the recording medium may be appropriately changed as long as before the irradiator. For example, the order may be before the liquid composition is applied to the recording medium, after the liquid composition is applied to the recording medium, or at the same time as when the liquid composition is applied to the recording medium. In addition, the region to which the curable composition is applied can be appropriately changed and, for example, may be the same portion as the liquid composition.

The curable composition contains, for example, a polymerization initiator and a polymerizable compound, and may contain other components such as a colorant and an organic solvent (organic solvent) as necessary.

—Polymerization Initiator and Polymerizable Compound—

As the polymerization initiator and the polymerizable compound, the ultraviolet polymerization initiator, the ultraviolet polymerizable compound, and the like mentioned in the above description of the liquid composition can be used. The polymerization initiator is a material capable of generating active species, such as radical and cation, by the light irradiated by the irradiator, to cause polymerizable compounds (e.g., monomer and oligomer) to initiate a polymerization. Examples of the polymerization initiator include radical polymerization initiators, cationic polymerization initiators, base generators, and combinations thereof. In particular, radical polymerization initiators are preferable. In order to secure a sufficient curing speed, the content rate of the polymerization initiator in 100% by mass of the curable composition is preferably in the range of from 5% to 20% by mass.

Specific examples of the radical polymerization initiators include, but are not limited to, aromatic ketones, acylphosphine oxide compounds, aromatic onium salt compounds, organic peroxides, thio compounds (e.g., thioxanthone compounds and thiophenyl-group-containing compounds), hexaaryl biimidazole compounds, ketoxime ester compounds, borate compounds, azinium compounds, metallocene compounds, active ester compounds, carbon-halogen-bond-containing compounds, and alkylamine compounds.

In addition, a polymerization accelerator (or sensitizer) may be used in combination with the polymerization initiator. Specific examples of the polymerization accelerator include, but are not limited to, amine compounds, such as trimethylamine, methyldimethanolamine, triethanolamine, p-diethyl aminoacetophenone, ethyl p-dimethylaminobenzoate, 2-ethylhexyl p-dimethylaminobenzoate, N,N-dimethylbenzylamine, and 4,4′-bis(diethylamino)benzophenone. The content of the polymerization accelerator is determined according to the type and amount of the polymerization initiator used in combination.

—Colorant—

Examples of the colorant include pigments and dyes having a color such as black, white, magenta, cyan, yellow, green, and orange, or a metallic color such as gold and silver. The colorants mentioned in the above description of the liquid composition can be used.

The content rate of the colorant can be appropriately determined depending on a desired color density and dispersibility of the colorant in the curable composition. Preferably, the content rate of the colorant in 100% by mass of the curable composition is in the range of from 0.1% to 20% by mass. Alternatively, the curable composition may contain no colorant to be colorless and transparent. In this case, the curable composition is preferably used for an overcoat layer (a protector coat layer) for protecting an image.

—Organic Solvent—

As the organic solvent, for example, any organic solvent described in the above description of the liquid composition can be used. The curable composition may contain an organic solvent, but preferably does not contain the organic solvent if possible. When the curable composition includes no organic solvent, in particular, when the composition is VOC (volatile organic compound) free, a higher degree of safety is provided at sites where the composition is being handled while environment pollution is prevented. Here, the organic solvent refers to a typical non-reactive organic solvent, such as ether, ketone, xylene, ethyl acetate, cyclohexanone, and toluene. The organic solvent is discriminated from a reactive monomer. When the composition is stated to contain no organic solvent, it means that the composition “substantially” contain no organic solvent. In this case, the content rate of the organic solvent in the composition is preferably less than 0.1% by mass.

Examples of the other components include, but are not limited to, a surfactant, a polymerization inhibitor, a leveling agent, a defoamer, a fluorescence brightening agent, a permeation accelerator, a wetting agent (humectant), a fixing agent, a viscosity stabilizer, a fungicide, a preservative, an antioxidant, an ultraviolet absorber, a chelate agent, a pH adjuster, and a thickener.

—Preparation—

The curable composition may be prepared by: dispersing the polymerizable monomer, the pigment, the dispersant, etc., by a disperser (e.g., ball mill, KITI mill, disc mill, pin mill, DYNO-MILL) to prepare a pigment dispersion liquid; and further mixing the polymerizable monomer, the polymerization initiator, the polymerization inhibitor, a surfactant, etc., in the pigment dispersion liquid. However, the preparation method is not limited thereto.

—Viscosity—

The viscosity of the curable composition is not limited to any particular viscosity and is adjusted in accordance with the purpose of use or application. When the curable composition is applied to a discharge device that discharges the composition from nozzles, the viscosity of the composition is preferably adjusted to from 3 to 40 mPa·s, more preferably from 5 to 15 mPa·s, and most preferably from 6 to 12 mPa·s, at a temperature of from 20° C. to 65° C., more preferably at 25° C. Preferably, the curable composition exhibits a viscosity within the above-described range without containing any organic solvent. The viscosity can be measured with a cone-plate rotary viscometer (VISCOMETER TVE-22L available from Toki Sangyo Co., Ltd.) using a cone rotor (1°34′×R24) while setting the revolution to 50 rpm and the temperature of the constant-temperature circulating water to from 20° C. to 65° C. The temperature of the circulating water can be adjusted by an instrument VISCOMATE VM-150III.

<Print Mode>

The image forming apparatus of the present embodiment may have a plurality of print modes (also referred to as operation modes), and one or more print modes can be selected. The print mode may be selected by an operator or by other means.

Examples of the print mode include a first print mode using only the first applicator among the applicators, and a second print mode using the second applicator. Here, the “second print mode using the second applicator” includes a case where the first applicator and the second applicator are used in combination and a case where only the second applicator is used.

In the present embodiment, at least one of the selectable print modes need to be a print mode in which the content of the ultraviolet polymerization initiator and the ultraviolet polymerizable compound in the liquid composition applied from the applicator to the recording medium is restrained to a predetermined amount, and the irradiator irradiates light having a predetermined peak wavelength. Such a selectable configuration of print modes can restrain the waviness of the blank portion, reduce the running cost, and obtain a printed matter having good safety.

For example, the apparatus may be configured to have a first print mode in which aqueous ink is applied by the first applicator and light is irradiated by the irradiator, and a second print mode in which UV ink is applied by the second applicator and light is irradiated by the irradiator, and to be capable of appropriately selecting the first print mode and the second print mode.

In the first print mode, it is preferable that only the liquid composition is applied to the recording medium without using the UV ink, the UV-curable pretreatment liquid, or the like, and the liquid composition is irradiated with light by the irradiator to perform drying. Such a configuration can restrain the waviness of the blank portion, reduce the running cost, and obtain a printed matter having good safety.

As the first print mode and the second print mode, for example, one or more of a monochrome mode, a full-color mode, a white mode, a special color print mode, and the like can be appropriately selected. For example, when the monochrome mode is selected, only the applicator that applies the liquid composition of black is used for image formation. When the full-color mode is selected, only the applicators that apply the liquid compositions of black, cyan, magenta, and yellow are used for image formation. When the white mode is selected, only the applicator that applies the white liquid composition is used for image formation. When the special color print mode is selected, only the applicator that applies the liquid composition containing no colorant is used for image formation.

A mixture of the liquid composition and the curable composition can be used by appropriately selecting the print mode. For example, a print mode in which the full-color mode and the white mode are used in combination may be employed. In such a case, a first applicator that applies liquid compositions of black, cyan, magenta, and yellow and a second applicator that applies a curable composition of white can be used. In addition, the full-color mode and the special color print mode may be used in combination. In such a case, a first applicator that applies liquid compositions of black, cyan, magenta, and yellow and a second applicator that applies a curable composition containing no colorant can be used. Alternatively, the monochrome mode and the white mode (and/or the special color print mode) may be used in combination. In such a case, a first applicator that applies a black liquid composition and a second applicator that applies a white curable composition and/or a curable composition containing no colorant can be used.

<Roller Conveying Unit>

The image forming apparatus according to the present embodiment may form an image on one side of a recording medium or may form images on both sides of a recording medium. In a case where images are formed on both sides of a recording medium, it is preferable that the image forming apparatus according to the present embodiment includes a roller conveying unit that conveys the recording medium while sandwiching the recording medium between two cylindrical members. However, the roller conveying unit is not limited to such a configuration but the configuration of the roller conveying unit can be appropriately changed.

When the roller conveying unit is provided, the applicator, the irradiator, and the roller conveying unit are provided in this order from the upstream side in the conveyance direction of the recording medium. After the light irradiation is performed by the irradiator, the recording medium is conveyed by the roller conveying unit, and the application of the liquid composition and the light irradiation are performed again on the back side (the side on which the image is not formed) of the recording medium.

According to the present embodiment, in the case of using the roller conveying unit, double-sided printing can be performed by reversing the front side and the back side of the recording medium with a simple configuration in comparison with the gripper conveyance in which the leading end of the recording medium is gripped. In the conveyance method using the roller conveying unit (hereinafter, also referred to as roller conveyance), the recording medium is conveyed while being sandwiched between two cylindrical members. Accordingly, the recording medium including an image portion (a portion to which the liquid composition is applied) is rubbed. However, using the above-described liquid composition and irradiator can dry the liquid composition without causing waviness of the blank portion and obtain a good printed image without rubbing marks due to roller conveyance.

The number of roller conveying units provided in the image forming apparatus may be one or more. Examples of the roller conveying unit also include a roller conveying unit that is used to reverse the recording medium. The cylindrical member (also referred to as a roller member or the like) is not particularly limited, and the diameter, the axial length, the material, and the like can be appropriately changed.

### Example 1 and Comparative Example 1

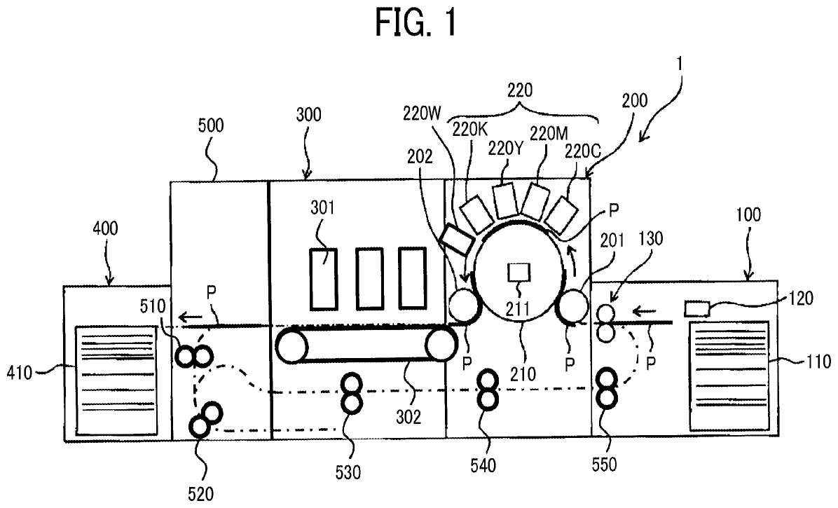

Next, an image forming apparatus according to the present embodiment is described using an example. Hereinafter, an example in which the liquid composition is mainly ink is described. FIG. 1 illustrates an image forming apparatus 1 according to the present embodiment. In the example of FIG. 1, an inkjet-type applicator is used. Therefore, the image forming apparatus of this example can also be referred to as an inkjet printing apparatus or the like.

The image forming apparatus 1 of the present embodiment includes a sheet feeding unit 100, an image forming unit 200, a drying unit 300, an ejecting unit 400, and a reversing unit 500 for double-sided printing. A sheet feeding device 120 conveys a sheet P one by one from a sheet feeding tray 110 of the sheet feeding unit 100. The sheet P is temporarily stopped by a registration roller pair 130 and then fed to the image forming unit 200 at a predetermined timing.

In the image forming unit 200, the sheet P is conveyed to a sheet carrying drum 210 via a receiving cylinder 201, and inkjet heads 220C, 220M, 220Y, 220K, and 220W (collectively referred to as inkjet heads 220 unless distinguished) form images on the sheet P (as an example of the applicator) on the sheet carrying drum 210. The time at which ink has been applied may be referred to as the time at which an image has been formed. Alternatively, the time after the light has been irradiated by the irradiator may be referred to as the time at which an image has been formed.

At this time, the inkjet heads 220 of different colors to be used for image formation are switched according to the print mode selected by the operator. The operator can select one type of print mode from three types of print modes, for example, a monochrome mode, a full-color mode, and a full-color and white mode, according to a print image.

When the monochrome mode is selected, only the inkjet head 220K is used for image formation, and the inkjet heads 220C, 220M, 220Y, and 220W remain protected by caps during printing operation.

When the full-color mode is selected, the inkjet heads 220K, 220C, 220M, and 220Y are used for image formation, and the inkjet head 220W remains protected by a cap during printing operation.

When the full-color and white mode is selected, all of the inkjet heads 220K, 220C, 220M, 220Y, and 220W are used for image formation.

In this example, a description is given of an example in which the full-color and white mode is selected. In this example, ink discharged by each of the inkjet heads 220K, 220C, 220M, and 220Y (first applicator) is an aqueous ink in which the content of the ultraviolet polymerization initiator and the ultraviolet polymerizable compound is restrained. The aqueous ink used here contains about 90% by mass of water and other high-boiling organic solvents, about 5% by mass of a resin, and about 5% by mass of a pigment. As the pigment, carbon black was used for the inkjet head 220K, copper phthalocyanine was used for the inkjet head 220C, quinacridone was used for the inkjet head 220M, and monoazo yellow was used for the inkjet head 220Y.

On the other hand, the ink discharged by the inkjet head 220W (second applicator) is a curable composition and is UV ink here. An acylphosphine oxide compound was used as a UV polymerization initiator, methacrylic acid was used as a UV polymerization monomer, and titanium oxide was used as a white colorant.

In FIG. 1, arrows indicate the conveyance direction of the sheet P, and ink is discharged onto the recording medium in the order of the inkjet heads 220C, 220M, 220Y, 220K, and 220W. However, the order of discharge is not limited to the above-described example.

After ink is applied to the sheet P, the sheet P is conveyed to the drying unit 300 via the delivery cylinder 202. In the drying unit 300, the sheet P is conveyed on a drying conveyance belt 302, and a UV light irradiation device 301 (irradiator) irradiates the sheet P with UV light, thereby drying a printed image.

Although three UV light irradiation devices 301 are illustrated in FIG. 1, embodiments of the present disclosure are not limited to the configuration. The number of the UV light irradiation devices 301 may be one or more. If a single UV light irradiation device is used to cover the amount of light necessary for drying, the size of the UV light irradiation device may be increased. Therefore, using a plurality of small UV light irradiation devices side by side can prevent an increase in the size of the UV light irradiation device and facilitate handling during maintenance.

After being irradiated with light, in the case of single-sided printing, the sheet P passes through the reversing unit 500 and is discharged to an ejection tray 410 of the ejecting unit 400. In the case of double-sided printing, the sheet P is conveyed to a reversing roller 520 via a conveying roller 510 by a branching claw. Here, the sheet P is temporarily stopped and then switched back to be conveyed in the reverse direction. The switched-back sheet P passes through the conveying rollers 530, 540, and 550 of the double-sided path and rejoins the registration roller pair 130 of the sheet feeding unit 100, and image formation on the back surface is started.

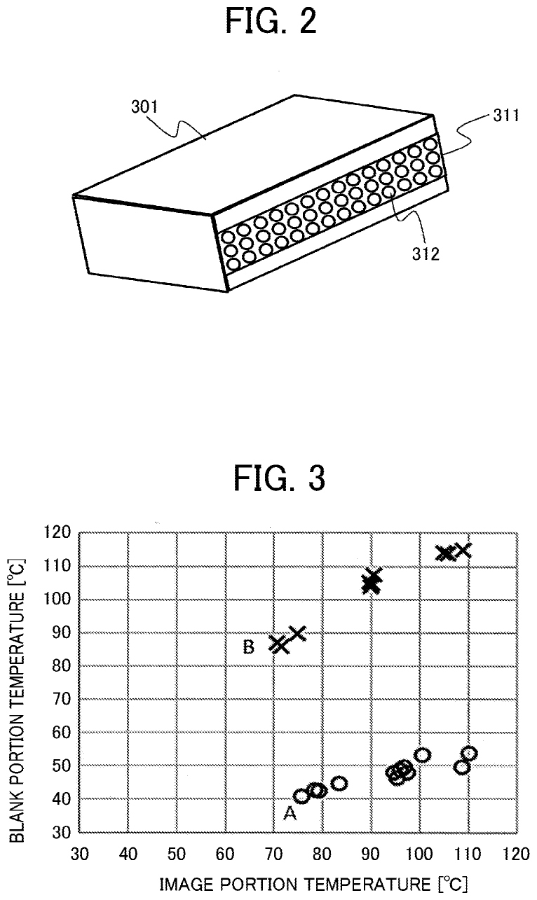

Next, drying by the drying unit 300 is described in detail. FIG. 2 is a schematic view of a UV light irradiation device 301 used in this example. FIG. 2 is a schematic view of the UV light irradiation device 301 as viewed from the side of the sheet P or the drying conveyance belt 302.

In this example, the surface of the UV light irradiation device 301 facing the sheet P or the drying conveyance belt 302 is a UV light irradiation surface 311, and UV-LED light emitting elements 312 are arranged in a grid pattern on the UV light irradiation surface 311. Since the UV-LED light emitting elements 312 emit light at the same illuminance, the UV light irradiation device 301 as a whole is in a state of uniformly emitting light along the UV light irradiation surface 311. As the wavelength of the irradiated light, a wavelength having a peak wavelength of 395 nm and a wavelength distribution having a full width at half maximum of about 15 nm was used.

FIG. 3 is a graph illustrating the correlation between image portion temperature and blank portion temperature after drying. FIG. 3 illustrates A representing the correlation between the image portion temperature and the blank portion temperature in the present embodiment including the present example and B representing the correlation between the image portion temperature and the blank portion temperature in a comparative example.

In the example of the present embodiment (A in FIG. 3), drying is performed by UV-LED. In the comparative example (B in FIG. 3), IR drying (drying by an IR lamp) is performed. The surface temperature of the sheet after passing through the drying was measured by changing the drying conditions (output settings of the IR lamp and the UV-LED), and the temperature of the image portion and the temperature of the blank portion were checked.

The same aqueous ink was used in both cases. It is known that when the temperature of an image portion is increased to about 90° C., evaporation of water and organic solvent in the aqueous ink proceeds to dry the aqueous ink. Here, a portion to which the aqueous ink is applied is defined as an image portion, and a portion to which the aqueous ink is not applied is defined as a blank portion.

In the IR lamp drying of the comparative example, when the temperature of the image portion was set to 90° C., the temperature of the blank portion was 105° C. at the same time. On the other hand, in the UV-LED drying of the present embodiment, when the image portion temperature was similarly set to be around 90° C., the blank portion temperature was around 45° C., which was about 60° C. lower than the blank portion temperature in the IR lamp drying.

Due to such a difference in the temperature of the blank portion, the moisture content of the blank portion decreased from 6.1% to 1.4% in the IR lamp drying, whereas the moisture content of the blank portion decreased only from 6.1% to 2.9% in the UV-LED drying, and it was confirmed that more moisture was retained in the blank portion after drying in the present embodiment.

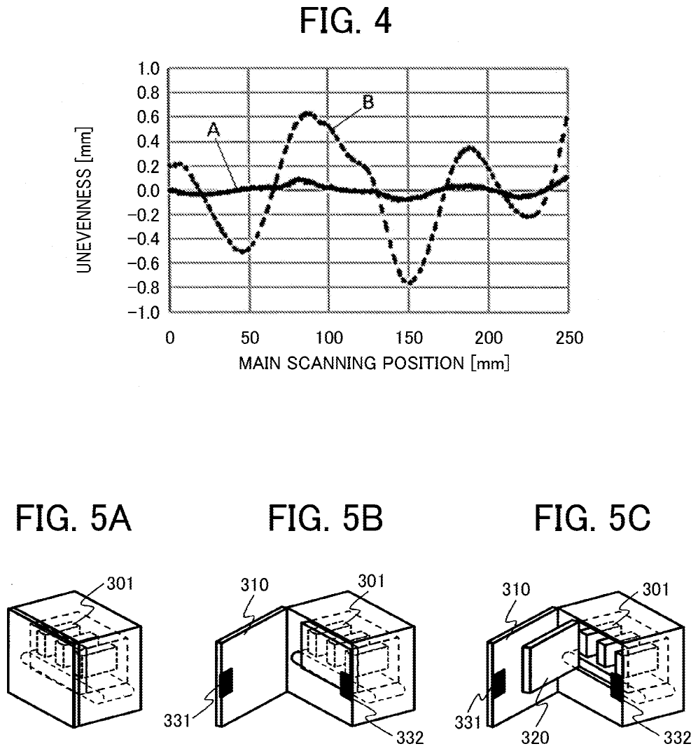

Next, FIG. 4 is a graph illustrating how much the blank portion is waved as a result of re-absorption of moisture after output. FIG. 4 illustrates the present example (A in FIG. 4) and the comparative example (B in FIG. 4). In FIG. 4, the main scanning position is defined as a distance in a direction perpendicular to the conveyance direction of a recording medium from an arbitrary point, which is set to be 0 mm, of the blank portion on the recording medium.

In the IR lamp drying (Comparative Example) in which a large amount of moisture of the blank portion was lost by the drying, the blank portion re-absorbed moisture after the output, and was greatly waved. The peak-to-peak height of the unevenness was about 1.4 mm at the maximum. On the other hand, in the UV-LED drying (the present example) in which the moisture of the blank portion was retained, the blank portion hardly reabsorbed moisture after the output, and thus the waviness hardly occurred. The height of the unevenness was within about 0.2 mm in peak-to-peak, and a good image with restrained waviness was obtained.

Next, a supplementary description is given of double-sided printing and roller conveyance in the present example and the present embodiment. As for the behavior of the sheet P in the reversing unit 500 at the time of double-sided printing in FIG. 1, as described above, when the sheet P on which the dried print image is formed is nipped and conveyed by the roller conveying unit, the force of rubbing the image surface with the roller member (cylindrical member) acts. In the reversing roller 520 of FIG. 1, the rotation speed of the roller member changes when the roller member is driven by forward rotation, when the roller member is temporarily stopped, and when the roller member is driven again by reverse rotation. As described above, when the rotation speed of the roller member changes, the force with which the image surface is rubbed by the roller member becomes particularly large.

In a print image conveyed by a roller member, if the drying strength of the print image is insufficient, a scratch or longitudinal band-shaped gloss unevenness may occur in a part rubbed by the roller member. In a conventional drying system, when the drying strength is sufficiently increased, waviness of a blank portion is deteriorated. Accordingly, it is difficult to restrain scratches and uneven glossiness in roller conveyance. In the present embodiment, even if the drying strength is sufficiently increased, the blank portion is not waved, and thus allowing the occurrence of scratches or uneven glossiness to be restrained during conveyance by the roller member.

### Example 2

Next, the image forming apparatus according to the present embodiment is described with reference to another example. FIGS. 5A to 5C illustrate the present example. FIGS. 5A to 5C are schematic views illustrating a cover structure of the irradiator. For the present example, in the above-described example 1, the UV light irradiation device 301 is surrounded by a double cover member including an outer cover 310 (second cover member) and an inner cover 320 (first cover member).

FIG. 5A illustrates a state in which both the outer cover 310 and the inner cover 320 are closed. In the present example, an operation of irradiating light can be performed only in this state. FIG. 5B illustrates a state in which the operator opens only the outer cover 310. An interlock device (a projection 331 and a switch 332) of the UV light irradiation device 301 is provided on the outer cover 310, and power is supplied to the UV light irradiation device 301 only in a state where the projection 331 of the interlock is stuck in the switch 332. As a result, when the outer cover 310 is opened and the projection 331 is removed from the switch 332, power supply to the UV light irradiation device 301 is interrupted, and UV light cannot be irradiated.

FIG. 5C illustrates a state in which the operator opens the outer cover 310 and then further opens the inner cover 320. In this state, the operator can visually check the UV light irradiation device 301 for the first time. Since the power supply to the UV light irradiation device 301 is already interrupted at the time when the outer cover 310 is opened, the UV light is not irradiated at the time when the inner cover 320 is opened, and the operator can safely work.

If such a double-cover structure is not adopted, there is a risk that the timing at which the interlock is cut off coincides with the timing at which the operator can visually check the UV light irradiator, and the operator views the UV light with a slight time lag until the UV light is turned off. However, adopting the double-cover structure as in the present example generates a time lag of the operation of the operator from opening the outer cover 310 to opening the inner cover 320. Such a configuration can guarantee that the UV light has been turned off at the time of opening the inner cover 320, thus increasing the degree of safety.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

1. An image forming apparatus comprising:
an applicator configured to apply a liquid composition containing water or an organic solvent onto a recording medium; and
an irradiator configured to irradiate the recording medium with light having a peak wavelength of 300 nm to 450 nm.

2. The image forming apparatus according to claim 1,
wherein the liquid composition comprises an ultraviolet polymerization initiator, and
wherein less than 0.1% by mass of the ultraviolet polymerization initiator is contained in the liquid composition.

3. The image forming apparatus according to claim 1,
wherein the liquid composition comprises an ultraviolet polymerizable compound,
wherein less than 5% by mass of the ultraviolet polymerizable compound is contained in the liquid composition.

4. The image forming apparatus according to claim 1,
wherein the liquid composition comprises an ultraviolet polymerization initiator and an ultraviolet polymerizable compound, and
wherein less than 0.1% by mass of the ultraviolet polymerization initiator and less than 5% by mass of the ultraviolet polymerizable compound are contained in the liquid composition.

5. The image forming apparatus according to claim 1,
wherein the liquid composition comprises at least one of water and an organic solvent, and
wherein a total content of water and the organic solvent in the liquid composition is 80% by mass or more.

6. The image forming apparatus according to claim 1,
wherein the irradiator includes a light emitting diode as a light source.

7. The image forming apparatus according to claim 1,
wherein the liquid composition comprises a colorant.

8. The image forming apparatus according to claim 1, further comprising another applicator configured to apply a curable composition to the recording medium before the irradiator irradiates the recording medium with the light, the curable composition being curable by the light irradiated by the irradiator.

9. The image forming apparatus according to claim 8,
wherein the image forming apparatus has a plurality of print modes including a first print mode using only the applicator and a second print mode using said another applicator, and
wherein one or more of the plurality of print modes are selectable.

10. The image forming apparatus according to claim 1, further comprising a roller conveying unit that includes two cylindrical members configured to convey the recording medium while sandwiching the recording medium between the two cylindrical members,
wherein the applicator, the irradiator, and the roller conveying unit are provided in this order from an upstream side in a conveyance direction of the recording medium, and
wherein, when images are formed on both sides of the recording medium, the recording medium is conveyed by the roller conveying unit after being irradiated with the light by the irradiator.

11. The image forming apparatus according to claim 1, further comprising:
a first openable cover member covering the irradiator; and
a second openable cover member covering the first openable cover member,
wherein the irradiator is configured to perform light irradiation when the second openable cover member is closed.
